(19) United States
(12) Patent Application Publication
(10) Pub. No.: US 2024/0241762 A1
(43) Pub. Date: Jul. 18, 2024

(54) AUTOMATED MIGRATION-FRAMEWORK FOR LIVE APPLICATIONS TO OPERATOR MANAGED ORCHESTRATION SYSTEMS

(71) Applicant: Red Hat, Inc., Raleigh, NC (US)

(72) Inventors: Brian Gallagher, Waterford (IE); Laura Fitzgerald, Waterford (IE)

(21) Appl. No.: 18/097,164

(22) Filed: Jan. 13, 2023

(51) Int. Cl. G06F 9/50; G06F 9/48

(52) U.S. Cl. CPC G06F 9/5055; G06F 9/4875

(57) ABSTRACT

A migration framework for orchestration-based application systems is disclosed. In an example a migration framework system comprises a live application, running on at least one node, via an orchestration system; a migration operator module configured to query, the live application based on a defined app migration custom resource; and retrieve, a data resource from the live application; an automated templating engine, for generating a new application custom resource, based on the data resource; and an application manager operator module to manage a migrated application, based on the new custom resource. In some frameworks, the generating of the new custom resource comprises defining, by the templating engine, values in a template application custom resource based on the retrieved data resource. The application manager operator module also can monitor continuously for at least one of additions or modifications to the new custom resource, or additional new custom resources.

### BACKGROUND

Open source container orchestration platforms (also referred to herein as an “application orchestration system”, or “orchestration system”) like Kubernetes, are software programs used to coordinate deployment and runtime lifecycle of scripts, applications, processes, and software running on a cluster of nodes and may also automate software deployment, scaling, and management across a target system. Kubernetes, for example, may be used as a target platform, where software, applications, or program instructions are provided to Kubernetes which then manages a large cluster of virtual, physical, hybrid, cloud machines, or a combination of these to manage the running of the software.

### SUMMARY

In an example a method is disclosed, comprising querying, by a migration operator, a live application, wherein the querying is based on an app migration custom resource (app migration CR); retrieving, by the migration operator, a data resource from the live application, wherein the data resource results from the querying; generating, by a templating engine, a new custom resource based on the data resource; and running, at least a component of the live application, by an application manager operator module, based on the new custom resource.

In an example a system is disclosed, the system comprising a live application, running on at least one node; a migration operator module configured to query, the live application, wherein the querying is based on an app migration custom resource (App Migration CR); and retrieve, a data resource from the live application; an automated templating engine, for generating a new custom resource, based on the data resource; and an application manager operator module to manage a migrated application, based on the new custom resource.

A non-transitory machine readable medium storing code, which when executed by a processor is configured to query, by a migration operator module, a live application, wherein the querying is based on an app migration custom resource; retrieve, by the migration operator module, a data resource from the live application, wherein the data resource results from the querying; generate, by a templating engine, a new custom resource based on the data resource; and run, at least a component of the live application, by an application manager operator module, based on the new custom resource.

Additional features and advantages of the disclosed method and system are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE FIGURES

FIG. 1 illustrates one aspect of the architecture of an orchestration system upon which the methods described herein may occur according to several aspects of the present disclosure.

FIG. 2 illustrates a flow diagram for a method to migrate an application product to an orchestration-based system utilizing an application manager operator module, according to at least one aspect of the present disclosure.

FIG. 3 illustrates a migration framework to transfer a software product to an application manager operator module-run system, according to at least one aspect of the present disclosure.

FIG. 4 presents a block diagram of a computer apparatus, according to at least aspect of the present disclosure.

FIG. 5 is a diagrammatic representation of an example system that includes a host machine within which a set of instructions to perform any one or more of the methodologies discussed herein may be executed.

### DETAILED DESCRIPTION

An orchestration system may be a Kubernetes run target system, or similar alternative platforms that may provide some or all of the functions of a Kubernetes system, for example, Docker, OpenShift, or Salt Stack. Typically, orchestration systems are run in an architecture that includes a master or controller node, and multiple worker nodes, the multiple worker nodes unified by a virtual layer that is able to utilize each of their individual resources. The controller node generally comprises an application/app manager operator module (also can be referred to as a “controller manager”, “operator”, “application manager operator”, “app manager operator” or “manager operator”) and manages the worker nodes. The operator automates system states by continuous reconciliation of the system with the desired or defined healthy state in deployment files such as YAML or JSON files.

The operator is the control mechanism of an orchestration system, generally it provisions applets, different applications, containers, and all forms of software necessary to run the service and brings them up to the desired state, and once it is up and running in the desired states it continuously polls the current state against the desired state as defined in the deployment files. Where there are deviations between the current state against the desired state it closes these deviations or brings them to the desired state.

Each worker node may contain a pod that in turn contains several application containers, the way the containers are distributed, the methods and scheduling of app deployment on worker nodes, as well as the number of instances of each container are all directed by the master or controller node. When a software file or instructions are received from a source, such as a client-side system, a logical unit called a deployment unit which holds information about the application is created, the deployment unit may be defined by a deployment file which may be a .yaml document or JSON file, the deployment file created by the user or client-side server or system is transmitted to the orchestration system target system via an API server or endpoint to have the orchestration system deploy and manage software according to instructions provided in the deployment file.

Resources defined in a deployment file and run on a Kubernetes target system may be very different from each other, each with their specific structure, classes, methods, or programming objects, each resource or document, for example an XML schema, a CSS file, a JavaScript file, or any app or scriplet, are all different and have their own specific functional characteristics. These resources may be utilized by the orchestration target system in a specific manner according to the specific characteristics, purpose, and functions of the resource. However, these resources may also share similar elements, or metadata. This metadata may be shared across all or a large number of resources across the orchestration system. For example, grouping information or files based on applications, user access information, file properties metadata, naming conventions, file types, labels, access restrictions, or other attributes may all be metadata shared across several if not all resources to be run on the Kubernetes target system.

Using an operator architecture, such as application manager operator module, to manage a Kubernetes based system, for example as currently provided for by an app manager operator module in Kubernetes and other orchestration systems, aims to remove the need for the human operation and management of a service or set of services. Using the application manager operator module, to manage new deployments is a well understood paradigm. A challenge in adopting the operator pattern is how to apply it to existing live software that does not deploy or utilize an app manager operator module. Specifically, there does not exist a migration framework, system, or method to migrate an already deployed product or piece of software that is not relying on an app manager operator module, into a system that is managed or controlled by an app manager operator module.

Technical difficulty arises in the transfer of the management of a deployed piece of software which may be managed by an administrator, or a combination of an administrator and an automated system to a fully automated process, involving a control loop, such as an application manager operator. Operators generally attempt to provision and then manage resources they have provisioned, and do not manage resources that have already been provisioned. Currently, to migrate an application to an operator managed system, an application, product, software, service, or system (referred to herein as “live application”) would have to be taken down and offline, a backup of the application data has to be made, or the data has to be exported. The live application has to be installed again as a new clean application on or with an orchestration system so that the application manger operator provisions it first, then the data that was exported is imported to bring the live application back to its previous state. This current practice causes delays and downtimes.

A current workaround of the traditional approach may involve reprovisioning all data and resources via the app manager operator and then migrate the stateful data of applications, such as its database. This would however also incur downtime, inefficiencies in allocation of computing resources, unnecessary duplications, and added complexity.

Techniques are disclosed herein for a migration framework that avoids downtime and any migration of the core application itself. Orchestration systems using an operator pattern or architecture utilize declarative data structures such as JSON and YAML files to define the desired state of a deployed/live application. Each individual software application/service will have domain specific attributes that will define its desired state.

The technologies disclosed herein utilize commonality between the orchestration systems, such as within all Kubernetes applications that can be leveraged to build a framework applicable to all apps. By examining the live system/resources it is possible to create a mapping to instances of declarative data structures or custom resource instances related to the new operator manager application. Therefore the migration framework technologies presented herein would be generally applicable, and able to achieve that transfer of management from an existing entity or network to an orchestration system managed by an application manager operator. Instead of having an application manager operator provisioning a new resource and then managing it, the application manager operator would instead discover an existing resource, define its existing state and then manage it accordingly.

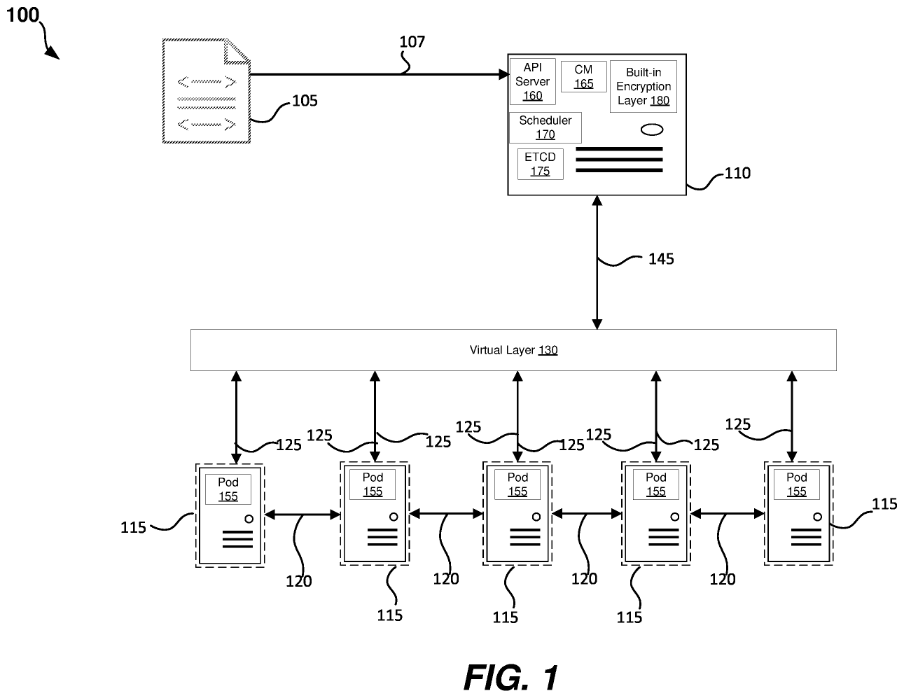

FIG. 1 presents one embodiment of an example Kubernetes or other application orchestration system upon which the methods described herein may be undertaken. The system 100 may include a master or controller node 110. The master or controller node 110 may be a standalone computing device, server, a software module, or a system comprised of multiple such devices. Controller node 110 hosts primarily the controller manager or app manager operator module 165 which controls the cluster and keeps track of the nodes and applications running on them. In some embodiments controller node 110 may also include an API server 160 which acts as the entry point of point of communication with controller node 110. There may also be a scheduler 170 which schedules application containers for each worker node 120.

The controller node 110 may be connected to one or more worker nodes 115, each of which may be made up of one or several computing, hardware, server and other such devices all connected with the controller node 110 in a cluster. The worker nodes 115 have various processes running on them including, an underlying program to allow communication between the worker nodes 115 and/or the controller node 110, for example a Kubernetes process, as well as pods 155 that may include container(s) running within them. Typically each pod 155 running on a worker node contains a number of containers. Worker nodes 115 may communicate 120 with each other through IP addresses or services/service calls that may be connected to the pods 155 in each worker node 115. The controller node 110 may connect 135B directly to the virtual layer 130 to communicate with the worker nodes 115.

The controller node 110 may also include an ETCD storage 175 that includes all configuration files, status data, and time snapshots of the worker nodes 115 that may be used for backups and recovery if a worker node 115 fails or if there is an outage. The virtual network or virtual layer may act as a virtual application or a virtual communication layer that runs across all worker nodes 115, unifying the worker nodes 115 to act as if they are one virtual machine and facilitates communications between the controller node 110, essentially allowing all worker nodes to act as a unified powerful virtual machine. Communications between the worker nodes 115 and the controller node 110 may also go through the virtual layer 130.

In various aspects a deployment file, custom resource, or document 105 that includes instructions, data and metadata, as well as sensitivity labels, categories, and classifications may be sent or transmitted 107 to the controller node 110 via the API server 160 from an operator, an external system, or client-side program/system. The metadata or label-level metadata may be classified as sensitive, or be assigned permission or access levels/attributes by the operator, or by the client-side program, or the process that sends the deployment file 105 to the master or controller node 110. The custom resource 105 may be a YAML file for instance, and defines the particular state of a resource being run in the orchestration system, for example a worker node 115 and/or a pod 155 running one or more containers, or even a container has to be running at certain processing thresholds/usage, must be running a number of instances, or certain tasks, functions, or applications.

In several aspects, the system 100 continuously monitors the states of applications, or other resources running on the system, via the controller node 110, to ensure that the deployment file 105 and its instructions regarding each deployed asset or resource is adhered to. If for any reason the state of the resource, its access level or access to a resource is modified or altered, then relevant worker nodes 115, or other components of system 100 may be notified, in many instances via an API call from controller node 110. The notification may be limited in the information provided describing the state of the resource that has changed, or it may be detailed containing information about the values that have been altered, the name, or other information about the label.

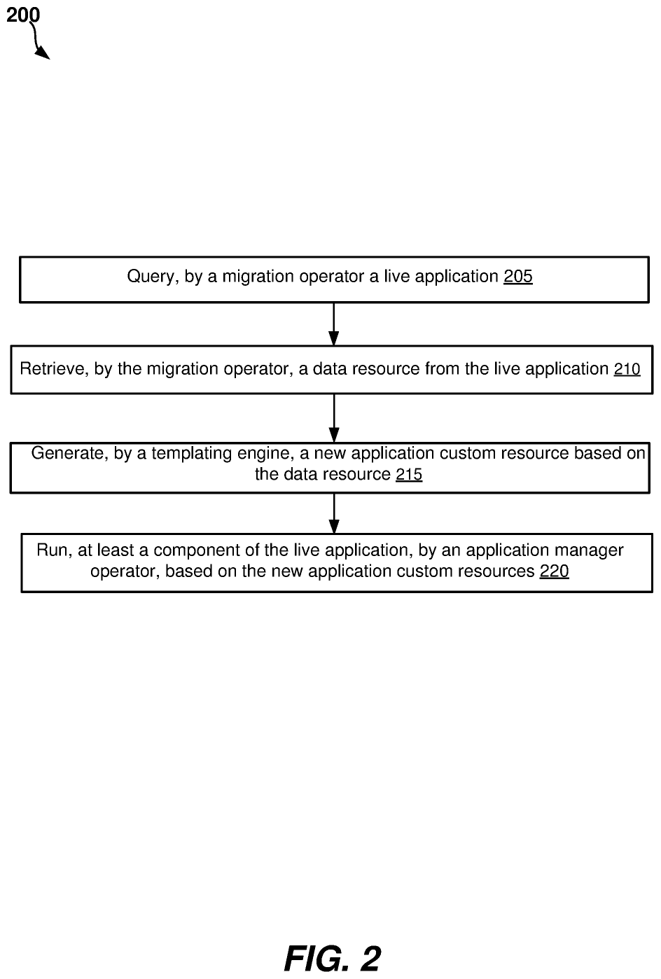

FIG. 2 illustrates a flow diagram for a method to migrate an application product to an orchestration-based system utilizing an application manager operator module, according to at least one aspect of the present disclosure. Method 200 can commence in various embodiments with querying 205 by a migration operator module a live application. The live application may be running on one or more nodes, for example worker nodes 115, FIG. 1, and in one pod 155, FIG. 1 and its container(s), or across different pods, containers, nodes or clusters. The live application is not utilizing or being managed by an app manager operator module, but is to be migrated via method 100 to be run and managed by the app manager operator module.

The querying may be done on various components of an orchestration system, for example a Kubernetes system, or a system 100, FIG. 1. For example, the API server 160, ETCD 175, the virtual layer, or any of the worker nodes 115 or their pods 155 may be queried, in addition to any other component of the orchestration system.

Method 200 may continue by the migration operator module retrieving 210 a data resource from the live application. The data resource can include as a file, data object, information, metadata, or response to a query by the live application and may be provided in various formats. The migration operator module receives this data resource, which can then be used by other parts of the migration framework, such as a templating engine or module, which generates 215 a new application custom resource based on the data resource.

Finally method 200 can include running 220 at least a component of the live application, by an app manager operator module, based on the new application custom resource. The new application custom resource may be a deployment file, for example a YAML file. Each new application custom resource that is generated 215 and forwarded or made available to the app manager operator module, app manager operator module, is detected by the app manager operator module, which then determines the state of a live migrated application and attempts to reconcile the state of the live migrated application with the desired state.

The desired state is set out in the new application custom resource that was generated 215 based on the data resources. For example, the app manager operator module may detect the generated 215 new application custom resource, and determine that the state of the application which is not running any task, application or function, does not match the desired or healthy state as defined by the new application custom resource, which for example defines the desired state as running a continuous photo stream or cloud platform. The app app manager operator module then will initiate the continuous photo stream or cloud platform or any other function or program so that the state of the migrated application matches that of the state defined by the deployment file/new application custom resource.

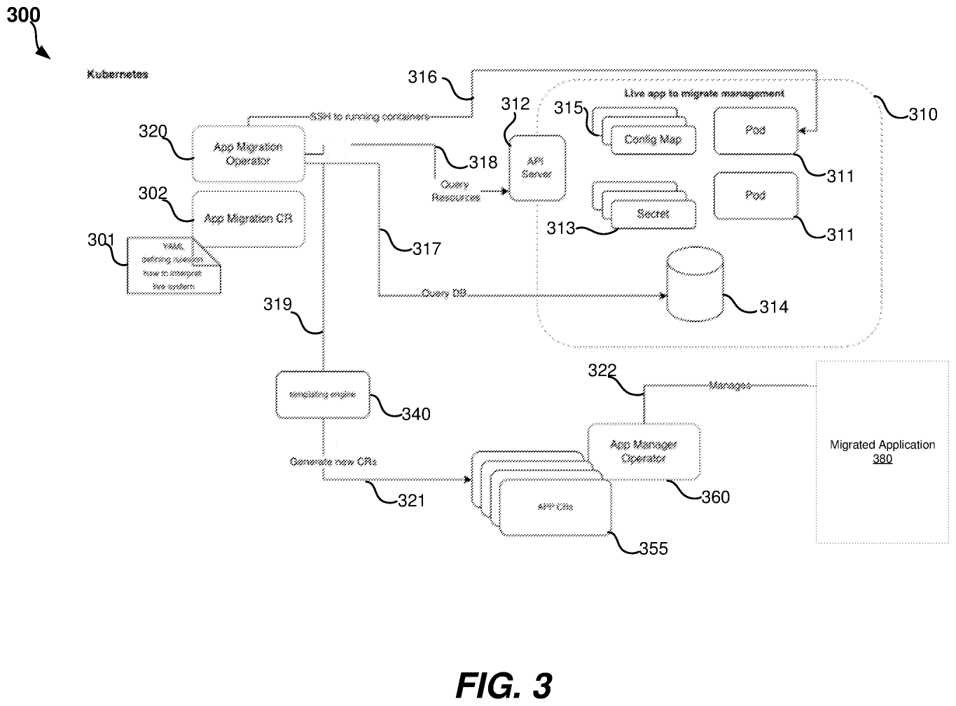

FIG. 3 illustrates a migration framework to transfer a software product, service or application to an application manager operator-run orchestration system, according to at least one aspect of the present disclosure. Migration framework 300 facilitates a migration method, such as method 100, FIG. 1 to migrate a live application 310 from a system that does not utilize an app manager operator module 350 to one that does, i.e., a migrated application 380 that can comprise any or all components of live app 310. In various embodiments, live application 310 is comprised of at least one of a configuration map 315, a configuration file, one or more secrets or stacks of secrets 313, a database 314, for example an application relational database, or ETCD 175, FIG. 1, a container, a pod 311, for example pod 155, FIG. 1, an API server 312, for example API server 160, FIG. 1, or an API endpoint.

Framework 300 includes a deployment file or custom resource 301. There may be multiple custom resources 301 that may be used to define how to undertake various functions and tasks by an orchestration system or by various modules and operators. One or more custom resources 301 may be used to generate an app migration custom resource 302 (referred to herein as “app migration CR”). App migration CR 302 can be defined before being deployed in framework 300, for example by a programmer, or a system administrator, or it may be automatically defined by a pre-migration module that can detect the live application 310 to be migrated, and determine what needs to be provided or defined app migration CR 302, for examples rules defining queries to be made to different components in framework 300, data required for the migration, and data needed to be processed for an app manager operator module, or app manager operator module 360.

Live application 310 can be run in an architecture similar to system 100, FIG. 1. App migration CR 302 defines rules on how to interpret a live system, for example live application 310, on how to migrate live application 310 to migrated application 380 managed by an app manager operator module 360. In several embodiments, the deployment of a custom resource 301 or an APP migration CR 302 within framework 300, for example across one or more nodes or computing devices, initiate the migration of live application 310 to migrated application 380. App migration CR 302 also defines what data resources, data objects, files, or information to retrieve, and from which components of live application 310, they should be retrieved from. App migration CR 302 therefore may define what components to query 205, FIG. 3, and what information or data resources to retrieve 210, FIG. 2 from live application 310.

App migration operator 320 (also “migration operator 320”) can be a software or hardware module, or a combination of both, designed to implement rules, state definitions, desired states, and functions provided by app migration CR 302. App migration operator module 320 may in numerous embodiments undertake querying 205, FIG. 2 and retrieving 210, FIG. 2 from live application 310. The querying 205 and retrieving 210 allow app migration operator module 320 to examine the live application 310 and its resources to facilitate the migration to an operator based system 380 by allowing app migration operator module 320 to create a mapping to instances of declarative data structures or custom resource instances related to a new operator such as app manager operator module 360.

In several embodiments app migration operator 320 derives migration rules, from the App Migration CR 302, wherein the migration rules define or prescribe at least one component of the live application 310 to query 205 and retrieve 210 information from. This information that is retrieved 210 allows migration operator module 320 to obtain and/or generate information/data and in some instances generate new custom resources 355 required by app manager operator module 360 to take over the management of the live application 310 and its related services.

In several embodiments, the querying 205, FIG. 2 of the live application 310 comprises querying at least one of a pod 311, a container, an API server 312, or a database 314. These queries may be pluggable and modifiable based on the app migration CR being deployed, the live application 310, and the requirements for migrating live application 310. In most embodiments migration operator module 320 will expose app migration CR 302 allowing the specification of the queries and translations required to create the new CRs 355.

Various pluggable and modular query engines, and combinations of which may be deployed by migration operator module 320. For example a query dsl (DomainSpecificLanguage) engine that specifies the domain specific queries to interpret the existing resources in live application 310. This query 205, FIG. 2 may undertake a standard bash command in the file directories of the live application 310 in containers or pods 311 for example to retrieve 210, FIG. 2 specific resources as prescribed by app migration CR 302.

Another pluggable modular query engine, a database query engine 317 can also be deployed by migration operator module 320. Taking the database queries specified in app migration custom resource 302 and translating them into, for example, an SQL query, and querying 205, FIG. 2 database 314 and parsing and returning/retrieving 210, FIG. 2, the data or data resource. A third query engine can comprise an API query engine 318 which uses REST APIs, including Kubernetes APIs, to query resources of live application 310 via API server or API node 312.

In several aspects a container query engine 316 may also be deployed, which connects or establishes a connection to live application 310, for example by using a secure shell protocol (SSH) or other encrypted communication or tunneling methods, and then runs various commands, for example bash commands to access and retrieve 210, FIG. 2 data resources from containers or pods 311. These query engines are pluggable and modular components of migration framework 300 that allow for extensibility in case other query engines are added for different components of live application 310. The various querying engines facilitate both application configuration and application state which may be required by the given target app manager operator module 360 to run migrated application 380.

After retrieving 210, FIG. 2 data resources, migration operator module 320 may forward 319 the resources, raw data, and information retrieved 210, to a templating engine 340, that takes the raw data retrieved 210 from queries 205 and creates or generates 321, 215, FIG. 2, new custom resources 355 for a migrated version 380 of live application 310 or a migrated application 380, (these new custom resources may be referred to herein as “new application custom resources” or “APP CRs”). Templating engine 340 may in several embodiments input the raw data into a template application custom resource with empty fields and values, and input the values of the raw data to fill these values generating completed APP CRs 355 for the migrated version 380 of the live application 310.

App manager operator module 360 taking over the management of the resource is provided awareness of the need to discover rather than provision a resource based on the new application CRs. This could in various embodiments be achieved with an annotation on the new application CRs to be added by templating engine 340. In several embodiments, when a new application CR is generated 321, 215, it is provided or transmitted to app manager operator module 360, and in other embodiments it is made available to app manager operator module 360 in a location the app manager operator module 360 polls or checks for automatically or continuously.

In several embodiments, app manager operator module 360 detects new application custom resources 355 and implements their desired or healthy defined state in a migrated version of live application 310. The implementing of the defined stated can comprise running, at least a component of the live application 310, based on new application custom resources 355. App manager operator module 360 can, in several embodiments, monitor continuously application custom resources 355, for changes, additions to APP CRs 355, as well as for newly added APP CRs 355, that may add new features or components of live application 310. As app manager operator module 360 implements an APP CR 355, the corresponding running component, container, or pod 311, in the original live application 310 may be taken down or deleted. As new APP CRs 355 are generated 321, 215, by templating module 340 and app manager operator module 360 runs these components, their running corresponding versions in live application 310 may be taken down, until all of live application 310 is taken down and replaced by a migrated application 380. The processes described in FIG. 2-3 are completely automated because of the systems and methods described herein, allowing a system to achieve migration upon the availability of the migration framework 300.

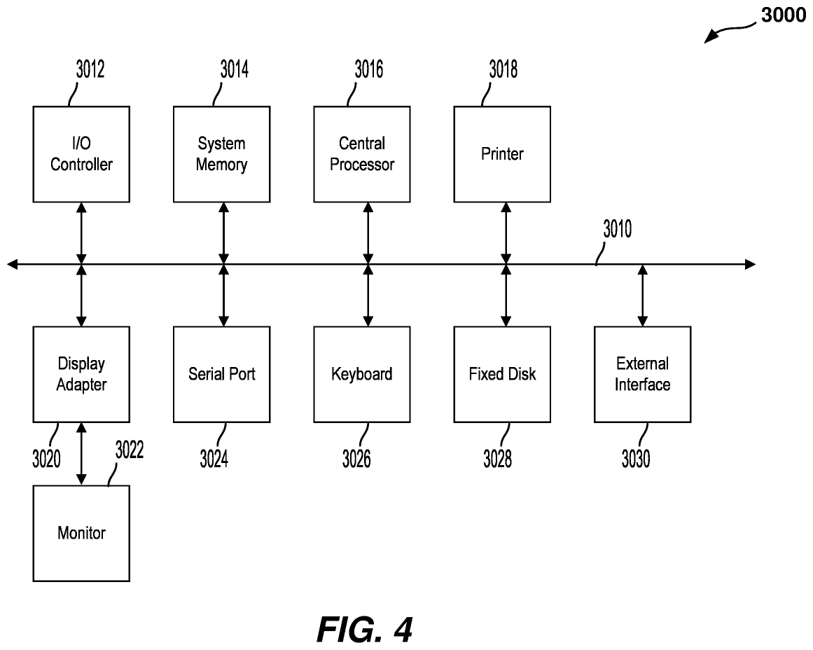

FIG. 4 is a block diagram of a computer apparatus 3000 with data processing subsystems or components, which a set of instructions to perform any one or more of the methodologies discussed herein may be executed, according to at least one aspect of the present disclosure. The subsystems shown in FIG. 4 are interconnected via a system bus 3010. Additional subsystems such as a printer 3018, keyboard 3026, fixed disk 3028 (or other memory comprising computer readable media), monitor 3022, which is coupled to a display adapter 3020, and others are shown. Peripherals and input/output (I/O) devices, which couple to an I/O controller 3012 (which can be a processor or other suitable controller), can be connected to the computer system by any number of means known in the art, such as a serial port 3024. For example, the serial port 3024 or external interface 3030 can be used to connect the computer apparatus to a wide area network such as the Internet, a mouse input device, or a scanner. The interconnection via system bus allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer readable medium.

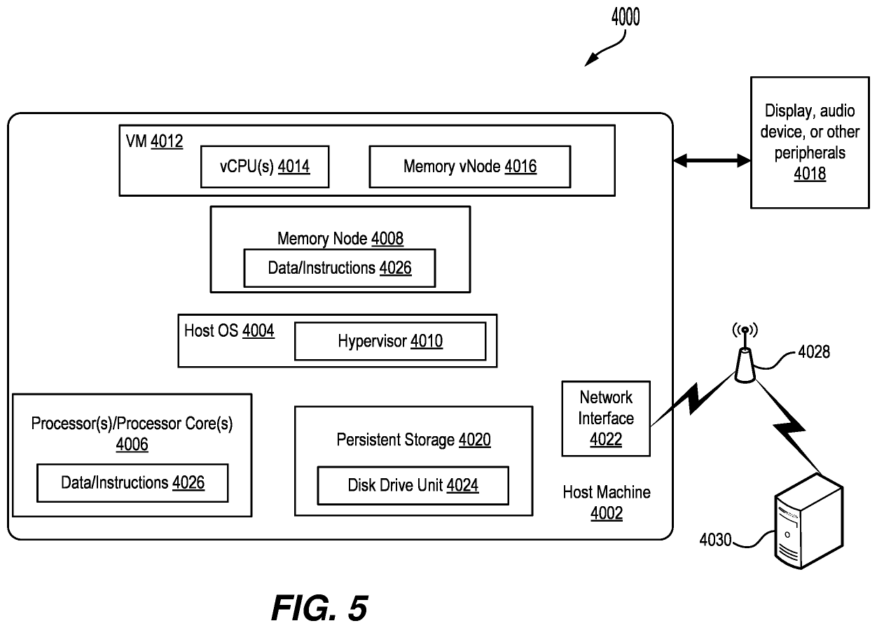

FIG. 5 is a diagrammatic representation of an example system 4000 that includes a host machine 4002 within which a set of instructions to perform any one or more of the methodologies discussed herein may be executed, according to at least one aspect of the present disclosure. In various aspects, the host machine 4002 operates as a standalone device or may be connected (e.g., networked) to other machines. In a networked deployment, the host machine 4002 may operate in the capacity of a server or a client machine in a server-client network environment, or as a peer machine in a peer-to-peer (or distributed) network environment. The host machine 3002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (“VM”) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to their corresponding vNodes 4016.

All the various components shown in host machine 4002 may be connected with and to each other, or communicate to each other via a bus (not shown) or via other coupling or communication channels or mechanisms. The host machine 4002 may further include a video display, audio device or other peripherals 4018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker) a persistent storage device 4020 (also referred to as disk drive unit), and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the system 4000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 4030 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the method according to various aspects of the present disclosure are provided below in the following numbered clauses. An aspect of the method may include any one or more than one, and any combination of, the numbered clauses described below.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing.” “computing.” “calculating.” “determining.” “displaying.” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to.” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least.” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A. B. and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect.” “an aspect.” “an exemplification,” “one exemplification,” and the like means that a particular feature, structure, or characteristic described in connection with the aspect is included in at least one aspect. Thus, appearances of the phrases “in one aspect.” “in an aspect.” “in an exemplification,” and “in one exemplification” in various places throughout the specification are not necessarily all referring to the same aspect. Furthermore, the particular features, structures or characteristics may be combined in any suitable manner in one or more aspects.

As used herein, the term “comprising” is not intended to be limiting, but may be a transitional term synonymous with “including.” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an embodiment or aspect, but other elements may be added and still form a construct within the scope of a claim. In contrast, the transitional phrase “consisting of” excludes any element, step, or ingredient not specified in a claim. This is consistent with the use of the term throughout the specification.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A method comprising:
querying, by a migration operator, a live application, wherein the querying is based on an app migration custom resource (app migration CR);
retrieving, by the migration operator, a data resource from the live application, wherein the data resource results from the querying;
generating, by a templating engine, a new custom resource based on the data resource; and
running, at least a component of the live application, by an application manager operator module, based on the new custom resource.

2. The method of claim 1, further comprising:
forwarding, by the migration operator, the data resource to the templating engine.

3. The method of claim 1, further comprising:
detecting, by the application manager operator module, the new custom resource.

4. The method of claim 1, further comprising:
deriving migration rules, by an app migration operator from the app migration CR, wherein the migration rules defines at least one component of the live application to query.

5. The method of claim 1, wherein the app migration CR determines a component of the live application to query, from which the data resource can be retrieved.

6. The method of claim 1, wherein the app migration CR determines the data resource to be retrieved.

7. The method of claim 1, wherein the generating of the new custom resource comprises defining, by the templating engine, values in a template custom resource based on the retrieved data resource to be retrieved.

8. The method of claim 1, wherein the live application is comprised of at least one of a configuration map, a configuration file, a secret, a database, a container, a pod, an API server, or an API endpoint.

9. The method of claim 1, wherein the querying of the live application comprises querying at least one of a pod, a container, an API server, or a database.

10. The method of claim 1, wherein at least one of the app migration CR, or the new custom resource comprises at least one deployment file.

11. The method of claim 10, wherein the deployment file comprises a JSON or YAML file.

12. The method of claim 1, further comprising:
monitor continuously for at least one of additions or modifications to the new custom resource, or additional new custom resources.

13. A system, comprising:
a live application, running on at least one node;
a migration operator module configured to:
query, the live application, wherein the querying is based on an app migration custom resource (App Migration CR); and
retrieve, a data resource from the live application;
an automated templating engine, for generating a new custom resource, based on the data resource; and
an application manager operator module to manage a migrated application, based on the new custom resource.

14. The system of claim 13, wherein the migration operator module is further configured to:
forward, the data resource to the templating engine.

15. The system of claim 13, wherein the application manager operator module is configured to:
detect, the new custom resource.

16. The system of claim 13, wherein the application manager operator module is configured to:
monitor continuously for at least one of additions or modifications to the new custom resource, or additional new custom resources.

17. The system of claim 13, wherein the migration operator module is further configured to:
derive migration rules, from the app migration CR, wherein the migration rules defines at least one component of the live application to query.

18. The system of claim 13, wherein the live application is comprised of at least one of a configuration map, a configuration file, a secret, a database, a container, a pod, an API server, or an API endpoint.

19. The system of claim 18, wherein the querying of the live application comprises querying at least one of a pod, a container, an API server, or a database.

20. A non-transitory machine readable medium storing code, which when executed by a processor is configured to:
query, by a migration operator module, a live application, wherein the querying is based on an app migration custom resource;
retrieve, by the migration operator module, a data resource from the live application, wherein the data resource results from the querying;
generate, by a templating engine, a new custom resource based on the data resource; and
run, at least a component of the live application, by an application manager operator module, based on the new custom resource.
